(19) United States
(12) Patent Application Publication
(10) Pub. No.: US 2010/0062627 A1
(43) Pub. Date: Mar. 11, 2010

(54) CONNECTION MEMBER AND HARNESS CONNECTOR

(76) Inventors: Tsugio Ambo, Saitama (JP); Yoshikazu Tanaka, Saitama (JP); Tomokazu Matsumoto, Saitama (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/520,980

(22) PCT Filed: Sep. 12, 2007
(86) PCT No.: PCT/JP2007/067717

§ 371 Date: Nov. 11, 2009

(30) Foreign Application Priority Data
Dec. 28, 2006 (JP) 2006-354753
Dec. 28, 2006 (JP) 2006-354754
Dec. 28, 2006 (JP) 2006-354756

(51) Int. Cl. H01R 29/00

(52) U.S. Cl. 439/189

(57) ABSTRACT

A waterproof harness connector that is simple, highly reliable, and can branch a wire. An inner holder is inserted into an outer holder from an opening, and then, joints of wire terminals, where seal members are attached to wires, are inserted into wire terminal holding holes of the inner holder through wire terminal insertion openings of the outer holder. When a pin terminal is inserted into a pin terminal insertion hole of the inner holder, the pin terminal penetrates tubular contacts of the joints, which are placed in the holding hole, to electrically connect the wire terminals to each other. After that, a waterproof member is fixed to an opening to make the inside of the outer holder a waterproof structure.

### FIELD OF THE INVENTION

The present invention relates to a connection member and a harness connector for use in harness circuits provided in, for instance automobiles.

### BACKGROUND OF THE INVENTION

In a harness circuit for use in automobiles, it is often required to provide one or more branch electric wires from a main electric wire. Heretofore, there have been widely proposed two joint methods, i.e. a splice joint method in which a part of an electrically insulating sheath of the main electric wire is removed and one or more branch electric wires are connected by clamping them to an exposed core conductor of the main electric wire, and a joint connector method in which a circuit branch connector is arranged at a terminal of the main electric wire and conventional connectors having clamp terminals connected to the main wire and branch wires are inserted into the circuit branch connector to constitute the branch circuit. The later method is disclosed in a Japanese Patent Document 1 mentioned later.

Japanese Patent Document 1:

Japanese Utility Model Kokai Hei 4-27587

### DISCLOSURE OF THE INVENTION

### Problems to be Solved by the Invention

In the splice joint method, electric wires have to be connected to the main electric wire in such a manner that a group of one to three branch wires is connected by clamping, and therefore after connecting the branch wires, the harness is difficult to be handled. Moreover, the joint work could not be carried out on a manufacturing line, and therefore the splice joint method is not suitably applied to the line production.

The joint connector method has been developed to overcome the above mentioned drawbacks of the splice joint method. In the joint connector method, the joint connection can be performed on a harness manufacturing line, and therefore a production efficiency is superior to the splice joint method and a design change of harness circuit can be easily effected. However, the number of parts such as connectors, cooperating conventional connectors, bus bars, connection terminals and so on is increased, and thus a relatively longer time period is required for assembling harness circuits.

In the known branch circuit structure disclosed in the Japanese Patent Document 1, a plurality of terminal fittings accommodated within a housing are short-circuited by means of a single short-circuiting plate member.

However, the branch circuit structure disclosed in the Japanese Patent Document 1 has the following problems.

(1) Terminal fitting has complicated construction.

(2) The terminal fitting can be inserted only in one direction.

(3) Since the short-circuiting plate member has a plate shape, the short-circuiting plate member could not be smoothly mounted on the terminal fittings.

(4) The branch circuit structure as a whole has a relatively large width, and therefore the branch circuit structure could not be easily arranged in the harness circuit.

(5) A waterproof structure could not be easily realized.

That is to say, even the joint connector method has various problems to be solved. For instance, space saving of the harness circuit, improvement in workability, simplification of harness circuit structure and realization of waterproof internal structure are required.

The present invention has for its object to provide a connection member and a harness connector using the connector member, in which the above mentioned problems can be solved, a waterproof structure is attained, a simple manufacturing process is realized, and a wire harness can be assembled efficiently.

### Merits of the Invention

In the connection member and harness connector according to the invention, an inner holder is inserted into an outer holder and a pin terminal is inserted into the inner holder via a wire terminal insertion hole formed in the outer holder, and therefore electric terminals can be electrically connected to each other within the inner holder and a reliability of the electrical connection and water proof property are improved and furthermore superior space factor, workability and cost reduction can be realized.

Moreover, the complicated construction is shared by the inner and outer holders, and therefore the connection member and harness connector can be easily manufactured.

Furthermore, the harness connector can be small in size, and thus the harness connector can be arranged at any desired position within the wire harness and a given circuit arrangement can be realized without extending electric wires. Particularly when the harness connector is used in the harness circuit for automobiles, the connection structure can be extremely simplified as compared with the known joint structures and the wire harness can be manufactured within a shorter time period.

### BRIEF DESCRIPTION OF THE DRAWINGS

FIG. 1 is an exploded perspective view showing a first embodiment 1 of the harness connector according to the invention;

FIG. 2 is a perspective view illustrating an inner holder, while a part of the inner holder is cut away;

FIG. 3 is a perspective view depicting a modification of a wire terminal;

FIG. 4 is a cross sectional view showing a pin terminal;

FIG. 5 is a perspective view representing an assembled condition of the harness connector;

FIG. 6 is a longitudinal cross sectional view showing the harness connector;

FIG. 7 is an exploded perspective view illustrating a second embodiment 2 of the harness connector;

FIG. 8 is a longitudinal cross sectional view showing the harness connector;

FIG. 9 is an exploded perspective view illustrating a third embodiment 3 of the harness connector;

FIG. 10 is a cross sectional view depicting the inner holder;

FIG. 11 is a cross sectional view showing the harness connector during the assembling;

FIG. 12 is a cross sectional view illustrating the assembled harness connector;

FIG. 13 is a side view of the harness connector, while only the outer holder is shown by a cross sectional view;

FIG. 14 is a perspective view illustrating a jig for removing the wire terminal; and

FIG. 15 is an explanatory figure for explaining the operation of the jig.

### EXPLANATION OF THE REFERENCE NUMERALS

1 outer holder
1a wire terminal insertion opening
1b vacant space
1c opening
1d hinge
1e closing member
2 inner holder
2a wire terminal supporting hole
2b pin terminal insertion hole
2c engaging projection
2d locking projection
2e, 2f, 2g, 21 rib
2h movable supporting plate
2i locking claw
2j groove portion
2k operating tab
3 wire terminal
3a connecting portion
3b tubular contact
3c engaging hole
3e conductor clamping portion
3f sheath clamping portion
4 electric wire
5 pin terminal
6,8 waterproof member
6a, 8a corrugated portion
6b locking hole
7 sealing member

### BEST MODES OF THE INVENTION

Now the present invention will be explained in detail with reference to embodiments shown in the drawings.

### Embodiment 1

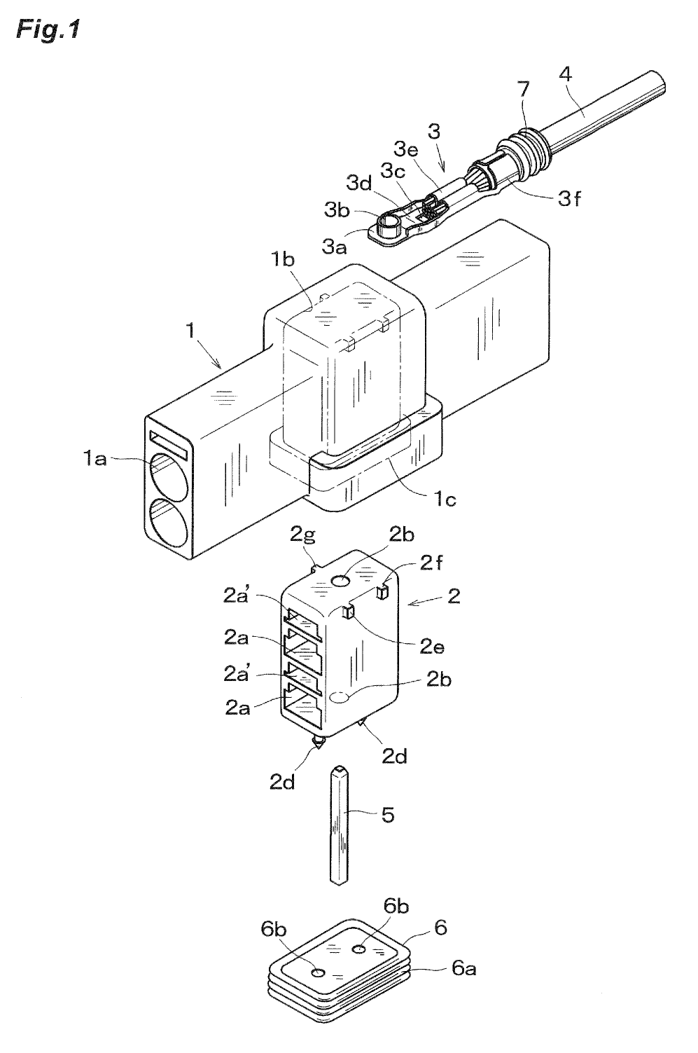

As shown in the exploded perspective view of FIG. 1, the harness connector of the present embodiment is mainly consisting of a rectangular outer holder 1 having a plurality of wire terminal insertion openings 1a formed therein; an inner holder 2 having wire terminal supporting holes 2a and a pin terminal insertion hole 2b; a plurality of wire terminals 3 each having a front end portion including a connecting portion 3a having a tubular contact 3b and a rear portion having an electric wire 4 connected thereto; a pin terminal 5; and a waterproof member 6 made of synthetic rubber.

The outer holder 1 has a plurality of wire terminal insertion openings 1a having a circular cross section, said wire terminal insertion openings extending from both end walls of the outer holder toward its center. In the present embodiment, in each of the end walls of the outer holder 1, there are formed two wire terminal insertion openings 1a. The outer holder 1 further includes a vacant space 1b into which the inner holder 2 is to be inserted from an inner holder insertion opening 1c formed in a bottom of the outer holder 1.

The outer holder 1 may be made of, for example a thermoplastic resin, and particularly polybutylene terephthalate (PBT) and polypropylene (PP) may be advantageously used due to their superior properties such as a high heat distortion temperature, a high mechanical rigidity, a high electrical insulation and high mechanical performances. A size of the outer holder 1 may be suitably determined, while considering the number of and thickness of the electric wires to be used. A length of the outer holder 1 is usually set to about 20-150 mm. In general, the outer holder 1 may be manufactured by injecting a thermoplastic resin into a suitable mold.

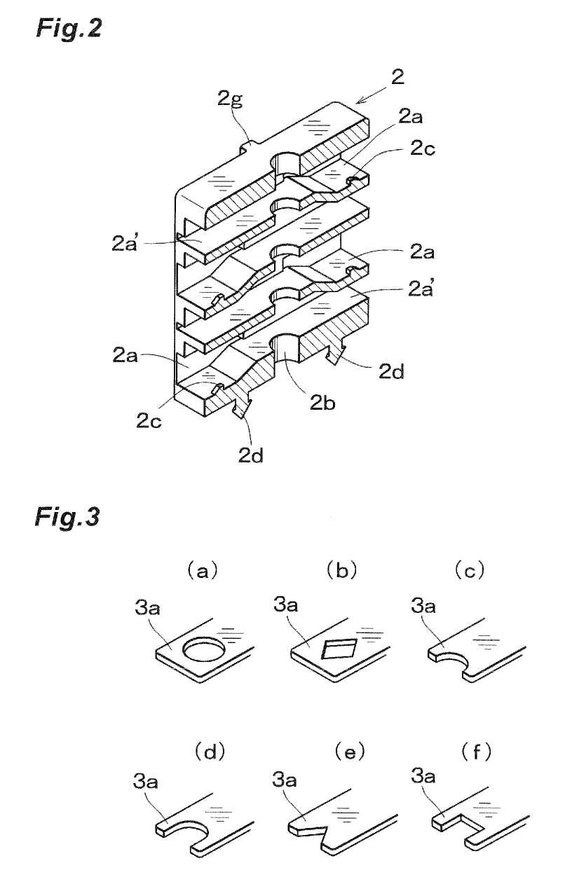

The inner holder 2 has a substantially cubic shape and includes the wire terminal supporting holes 2a as shown in a cross sectional view of FIG. 2. The wire terminal supporting holes 2a are communicated with the wire terminal insertion openings 1a, when the inner holder 2 is inserted into the outer holder 1. In this condition, the wire terminals 3 may be inserted into the wire terminal supporting holes 2a through the wire terminal insertion openings 1a of the outer holder 1. In FIG. 2, a reference numeral 2a′ denotes an opening which is opposed to an opening of the wire terminal supporting hole 2a from which the wire terminal is inserted. On a bottom of the wire terminal supporting hole 2a there is formed an engaging projection 2c which is to be engaged with the inserted wire terminal 3, said engaging projection 2c also serving to prevent an erroneous insertion of the wire terminal 3 into the inner holder 2 from the opening 2a′.

The pin terminal insertion hole 2b is formed in a vertical direction such that the pin terminal insertion hole 2b is communicated with the wire terminal supporting holes 2a within the inner holder 2. On a bottom of the inner holder 2 there are formed a plurality of hook-like locking projections 2d for locking the waterproof member 6 within the inner holder 2.

On one side wall of the inner holder 2, there are formed two ribs 2e and 2f and on the other side wall of the inner holder 2, there is formed a single rib 2g. In the vacant space 1b formed in the outer holder 1, there are formed recesses into which the ribs 2e, 2f and 2g are inserted when the inner holder 2 is inserted into the vacant space 1b of the outer holder 1.

The inner holder 2 may be made of a same material as the outer holder 1, but since the inner holder 2 is inserted within the outer holder 1, the inner holder 2 may be made of a material which does not have a heat resistance, although the outer holder 1 is required to have a heat resistance. The inner holder 2 may be formed by the injection mold, but when the inner holder 2 has a complicated inner structure, it may be divided into plural parts and these parts may be separately manufactured. Upon assembling, these parts may be united by cementing or engagement to form the inner holder.

The wire terminal 3 is formed by punching an electrically conductive metal plate, and includes a tongue-like connecting portion 3a provided at one end portion of the wire terminal, an inclined portion 3d and a conductor clamping portion 3e and a sheath clamping portion 3f provided at the other end portion of the wire terminal. In each of the connecting portion 3a, there is formed a short tubular contact 3b extending in a direction perpendicular to a plane of the connecting portion 3a and an engaging hole 3c which is to be engaged with the engaging projection 2c of the inner holder 2. Said tubular contact 3b is formed by a reducing mill into a cylindrical shape having a short length.

The electric terminal 3 may be formed by punching a copper or copper alloy plate or a Sn plated copper or copper alloy plate. A brass plate may be advantageously used due to its superior mechanical strength and electrical conductivity. When use is made of a Sn plated brass plate, an anticorrosion property is improved and a good electrical contact can be attained with respect to the pin terminal 5.

The tubular contact 3b may have any suitable shape as long as a good electrical conduction can be attained when the contact 3b is brought into contact with the pin terminal 5. It is preferable to provide tapered guides both at a root portion and a front portion of the tubular contact 3b such that the pin terminal 5 can be easily inserted into the tubular contact 3b from either directions. In the present embodiment, the contact 3b is formed as a tubular shape, but it may be formed to have other shape than tubular. For instance, the contact 3b may be formed into various shapes as shown in FIG. 3, (a) circular shape, (b) polygonal shape, or a cut-out having various shapes such as (c) semicircular shape, (d) U-shape, (e) V-shape, and (f) rectangular shape. In view of the conductivity and durability of the contact, it is preferable to form the contact 3b as the tubular contact.

The electric wire 4 may be formed by an electrically insulated wire having a conductor and an electrically insulating sheath applied around the conductor and may have a conventional diameter. The conductor may be formed by a stranded wire of soft or hard copper wires which have been commonly used in automobile harnesses, or may be formed by a single wire or a stranded wire of copper alloy wires such as Cu—Sn alloy wire having a sufficiently large tensile strength and a small diameter. The electrically insulating sheath may be made of known electrically insulating materials. In view of environment protection, non-halogen insulating material may be advantageously used.

The conductor of the electric wire 4 may be connected to the wire terminal 3 by conventional calking, welding, soldering or clamping. Among these connecting methods, the clamping portion 3e used in the present embodiment is preferable, because the clamping connection can be performed within a short time period and can attain a high electrical conductivity and a higher mechanical strength.

The pin terminal 5 is inserted into the pin terminal insertion hole 2b formed in the inner holder 2 and serves to electrically connect a plurality of the connecting portions 3a of the wire terminals 3 to one another. To this end, the pin terminal 5 is formed by a rod-like member made of an electrically conductive metal and having a circular cross sectional shape or a polygonal shape such as triangular shape, rectangular shape and pentagonal shape. It should be noted that the rectangular cross sectional shape is preferable, because the pin terminal 4a having the rectangular cross sectional shape can be easily manufactured, can be inserted into the pin terminal insertion hole 2b without a large force, and can attain a stable and positive conduction. In this case, the contact of the wire terminal 3 may be preferably formed to have tubular or circular shape.

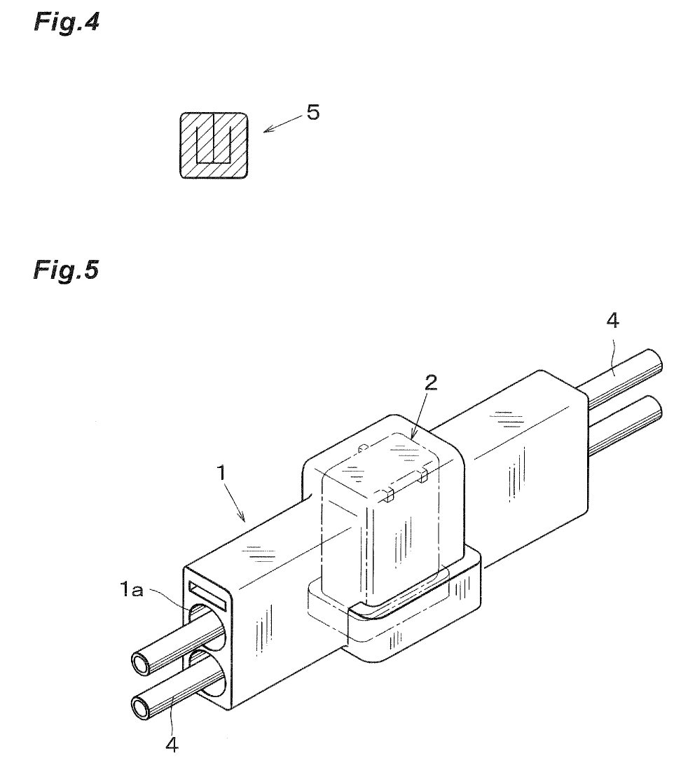

The pin terminal 5 is formed by folding an electrically conductive plate into a rectangular cross sectional shape as depicted in FIG. 4. Then, a top end of the pin terminal 4 is sharpened by pressing or cutting. In this manner, although use is made of the pin terminal 5 having a small cross sectional area, the pin terminal 5 can be protected against bending and break-down.

It is preferable to form the pin terminal 5 to have a higher hardness than the connecting portion 3a, and then the connecting portion 3a of the wire terminal 3 is deformed upon insertion of the pin terminal 5. Hardness of the pin terminal 5 and connecting portion 3a may be suitably adjusted by processing, thermal treatment and selection of materials. In order to insert the pin terminal 5 into the tubular contact 3b positively, the tip of the pin terminal 5 is preferably formed to have a cone shape such as circular cone, pyramid cone, cone frustum and pyramid frustum.

Now it is assumed that the circular or tubular contact of the connecting portion 3a has an inner diameter of d1 and the pin terminal 5 having a substantially rectangular cross section has a diagonal length of x, then it is preferable to set d1<x. Further, when the connecting portion 3a includes the contact having a rectangular cross section having a side of d1 and the pin terminal 5 has a circular cross section having an outer diameter of d2, then it is preferable to set d1<d2.

The waterproof member 6 is formed to have a cubic shape which is just fit into the inner holder insertion opening 1c of the outer holder 1. On an outer surface of the waterproof member 6 there is formed a corrugated portion 6a. In a top surface of the waterproof member 6 there are formed locking holes 6b into which the locking projections 2d of the inner holder 2 are inserted.

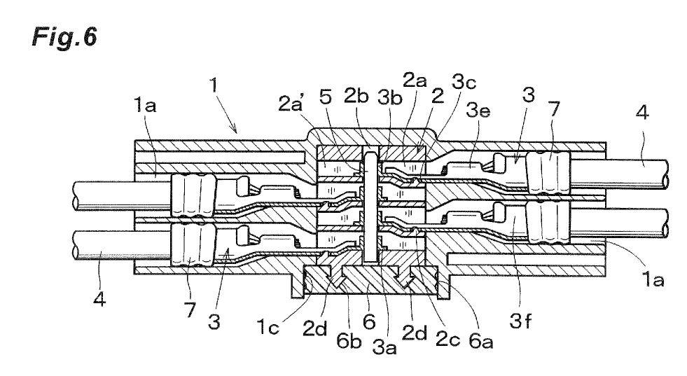

FIG. 5 is a perspective view and FIG. 6 is a cross sectional view showing the assemble condition. At first, the inner holder 2 is inserted into the vacant space 1b of the outer holder 1. This inserting operation is carried out such that the asymmetrically arranged ribs 2e, 2f and 2g are correctly fit into the recesses in the vacant space 1b, and therefore an erroneous insertion can be effectively prevented. Next, the four wire terminals 3 are inserted into the inner holder 2 through the four wire terminal insertion openings 1a of the outer holder 1 such that the engaging projections 2c of the inner holder 2 are inserted into the engaging holes 3c of the wire terminals 3.

In this manner, the wire terminals 3 are fixed at given positions, and a center of each of the tubular contacts 3b of the connecting portions 3a is aligned with a center of the pin insertion hole 2b of the inner holder 2.

In the present embodiment, the engaging projections 2c of the inner holder 2 are formed to be fixed, but the engaging projections 2c may be formed on movable levers so as to move up and down. Then, upon insertion of the wire terminal 3, the movable lever is moved downward and the engaging projection 2c can be easily inserted into the engaging hole 3c of the wire terminal 3. Furthermore, after pulling the pin terminal 5 out of the pin terminal insertion hole 2b, the engaging projection 2c can be easily removed from the engaging hole 3c by moving the movable lever upwardly by means of a suitable jig and the wire terminal 3 can be removed from the outer and inner holders 1 and 2.

Also in the present embodiment, since the tubular contacts 3b of the connecting portions 3a are stacked within the inner holder 2, in order to avoid interference between the tubular contacts 3b of the connecting portions 3a inserted from one end wall of the outer holder 1 and the tubular contacts 3b of the connecting portions 3a inserted from the other end wall of the outer holder 1, the wire terminal insertion openings 1a formed in one end wall of the outer holder 1 are shifted in the vertical direction with respect to the wire terminal insertion openings 1a formed in the other end wall of the outer holder 1. When the wire terminal 3 is inserted into the outer holder 1 and inner holder 2, the sealing member 7 is intimately brought into contact with an inner wall of the wire terminal insertion opening 1a, and penetration of water from the external can be prevented.

Since the tubular contacts 3b are provided on the connecting portions 3a, it is important to insert the connecting portions 3a into the wire terminal insertion openings 1a such that the tubular contacts 3b extend in a correct direction. If the connecting portions 3a are inserted such that the tubular contacts 3b extend in arbitrary direction, the connecting portions 3a could not be situated in given positions within the inner holder 2. Therefore, it may be necessary to provide suitable indications in terms of a direction of the tubular contacts 3b at entrances of the wire terminal insertion openings 1a.

When the pin terminal 5 is inserted into the pin terminal insertion hole 2b using a suitable jig, the pin terminal 5 passes through the tubular contacts 3b of the inserted wire terminals 3 and are brought into contact with the tubular contacts 3b, and the wire terminals 3 are electrically connected to one another. As long as the pin terminal 5 is not removed from the pin terminal insertion hole 2b, the wire terminals 3 could not be removed from the outer and inner holders 1 and 2.

Furthermore, when the waterproof member 6 is inserted into the opening 1c, the locking projections 2d of the inner holders 2 are inserted into the locking holes 6b formed in the waterproof member 6 and the waterproof member 6 could not be removed from the outer holder 1. Moreover, the corrugated portion 6a of the waterproof member 6 serves to prevent undesired penetration of water into the outer holder 1. The opening 1c of the outer holder 1 may be closed by a plate-like member made of synthetic resin to further improve the waterproof property provided by the water proof member 6.

In the embodiment 1 having the structure so far explained, the penetration of water into the outer holder 1 can be effectively prevented by means of the waterproof member 6 and the sealing members 7 provided on the electric wires 4. In this manner, the waterproof structure within the harness connector can be attained.

### Embodiment 2

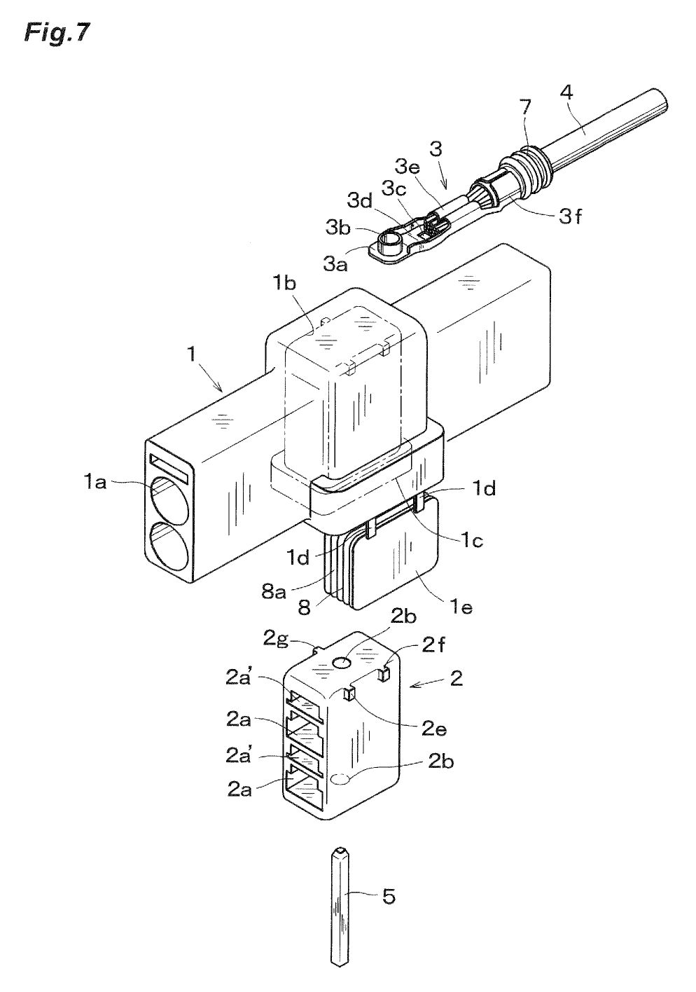

FIG. 7 is an exploded perspective view showing a second embodiment 2 of the harness connector according to the invention, said harness connector comprising an outer holder 1, an inner holder 2, wire terminals 3, a pin terminal 5 and a waterproof member 8.

In this second embodiment 2, the inner holder 2, wire terminals 3 and pin terminal 5 are substantially identical with those of the first embodiment 1, but a closing member 1e for closing an opening is of the outer holder 1 is rotatably secured to the lower portion of the outer holder 1 by means of hinges 1d and the waterproof member 8 including a corrugated portion 8a is secured to an inner surface of the closing member 1e by locking or cementing. Although not shown in the drawings, a locking mechanism is provided on the closing member 1e and opening 1c such that the closing member 1e might not be accidentally opened.

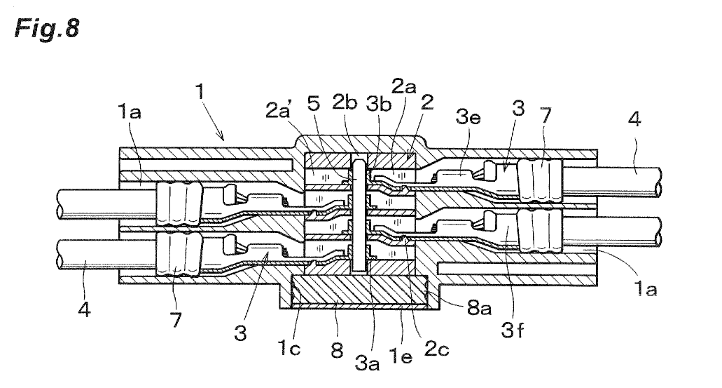

As illustrated in FIG. 8, when the waterproof member 8 is inserted into the opening 1c and the opening 1c is closed by the closing member 1e by turning the closing member 1e about the hinges 1d, the corrugated portion 8a of the waterproof member 8 can effectively prevent water penetration from the external into the outer holder 1. Like as the first embodiment 1, sealing members 7 are provided around to prevent water penetration into the outer holder 1 along the wire terminals 3.

### Embodiment 3

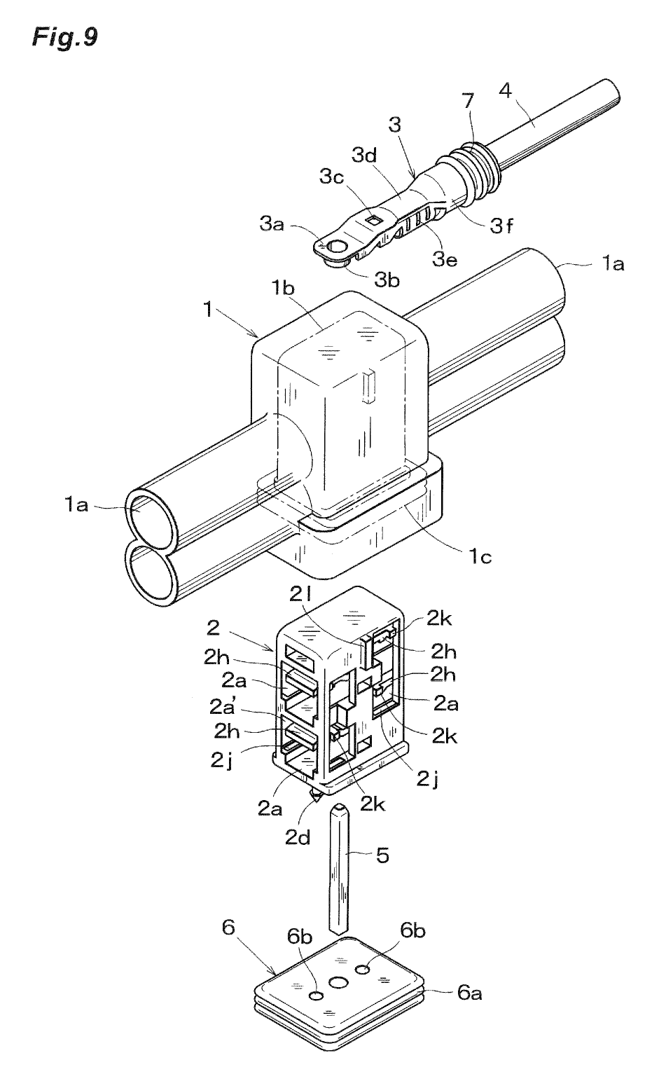

FIG. 9 is an exploded perspective showing a third embodiment 3 of the harness connector according to the invention. The harness connector comprises a cubic outer holder 1 having a plurality of wire terminal insertion openings 1a each consisting of a tubular member, an inner holder 2 including wire terminal supporting holes 2a and a pin terminal insertion hole 2b, a plurality of wire terminals 3 and a waterproof member 6 made of a synthetic rubber.

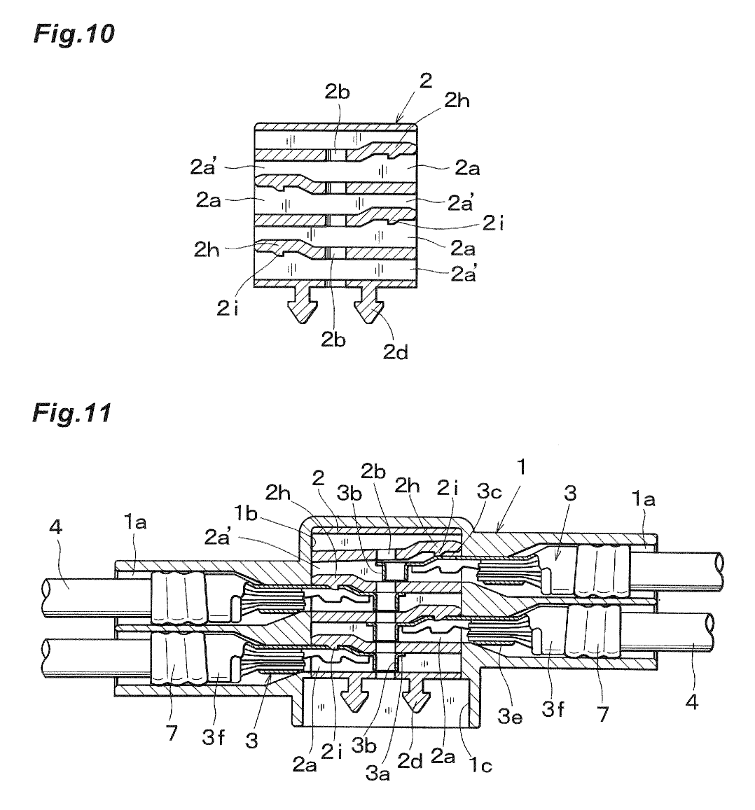

The outer holder 1 of this embodiment 2 has a similar shape to the outer holder 1 of the first embodiment 1, but the inner holder 2 of the present embodiment 2 is formed substantially as a cubic body having a structure depicted in a cross sectional view of FIG. 10. The inner holder 2 includes wire terminal supporting holes 2a extending horizontally, said wire terminal supporting holes 2a being communicated with the wire terminal insertion openings 1a when the inner holder 2 is inserted into the vacant space 1b formed within the outer holder 1, and said wire terminal supporting holes 2a supporting the connecting portions 3a of the wire terminals 3 when the wire terminals are inserted into the inner holder 2 through the wire terminal insertion openings 1a. The inner holder 2 further includes the pin terminal insertion hole 2b extending vertically, said pin terminal insertion hole 2b intersecting the wire terminal supporting holes 2a within the inner holder 2. It should be noted that a reference numerals 2a′ denotes an opening of the wire terminal supporting hole 2a opposite to an opening from which the wire terminal 3 is inserted into the wire terminal insertion hole. Above the wire terminal supporting holes 2a there are formed movable supporting plates 2h, and locking claws 2i are formed on rear surfaces of the movable supporting plates 2h, said locking claws 2i serving to fix the wire terminals 3 in position.

In the inner holder 2 there are formed slot portions 2j at both ends near the inlet openings of the wire terminal supporting holes 2a. A suitable jig may be inserted into the inner holder 2 through said slot portions 2j to move the movable supporting plates 2h upward. On both sides of respective movable supporting plates 2h there are formed operating tabs 2k extending outwardly. Positions of the operating tabs 2k provided on the vertically arranged movable supporting plates 2h are shifted horizontally.

Furthermore, on the bottom surface of the inner holder 2 there are formed two hook-like locking projections 2d for locking the waterproof member 6 in position. On one side of the inner holder 2 there is formed a rib 21, and a recess corresponding to said rib 21 is formed in an inner surface of the vacant space 1b into which the inner holder 2 is to be inserted.

FIG. 11 is a cross sectional view showing an assembled condition. When the inner holder 2 is inserted into the vacant space 1b of the outer holder 1, the inner holder 2 is locked at position by means of a suitable locking mechanism not shown in the drawings. During this inserting operation, the rib 21 formed asymmetrically on one side wall of the inner holder 2 is snapped into the recess formed in the vacant space 1b, and therefore undesired insertion of the inner holder 2 into the outer holder 1 can be prevented.

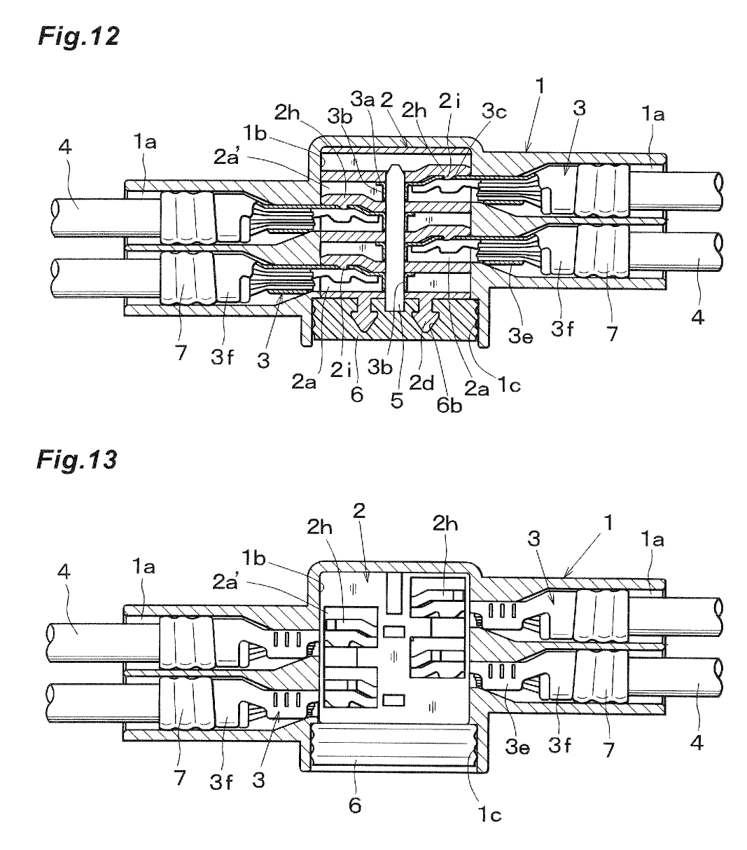

Next the wire terminals 3 are inserted into the four wire terminal insertion openings 1a of the outer holder 1. During this insertion operation, as shown by the upper right wire terminal 3 in FIG. 12, the connecting portion 3a pushes the movable supporting member 2h upwardly and is further inserted into the inner holder 2. Then, the locking claw 2i of the inner holder 2 is inserted into the engaging hole 3c and the movable supporting plate 2h moved downward as illustrated by the lower right wire terminal 3 in FIG. 12. In this manner, the wire terminal 3 is fixed at given position and the center of the tubular contact 3b of the connecting portion 3a is aligned with the center of the pin terminal insertion hole 2b.

After inserting all the wire terminals 3, as depicted in FIG. 12, the pin terminal 5 is inserted into the pin terminal insertion hole 2b using a suitable inserting jig such that the pin terminal 5 passes through the tubular contacts 3b of respective wire terminals 3 to electrically connect the wire terminals 3 to one another.

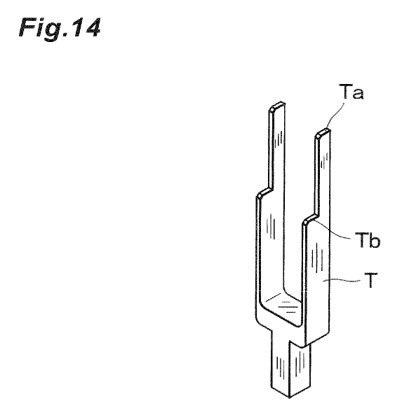

Next, when the waterproof member 6 is inserted into the opening 1c of the outer holder 1, the locking projections 2d of the inner holder 2 are inserted into the locking holes 6b of the waterproof member 6 and the waterproof member 6 is prevented from being removed from the outer holder 1. It should be noted that FIG. 13 is a cross sectional view showing only the outer holder 1 being in the same condition as that shown in FIG. 12.

FIG. 14 is a perspective view illustrating a jig T for pushing upward the operating tabs 2k of the inner holder 2 for removing the wire terminals 3 from the outer and inner holders 1 and 2. The jig T includes two end portions Ta and Tb. Since the two operating tabs 2k provided on the upper and lower movable supporting plates 2h are shifted horizontally, when the jig T is inserted into the inner holder 2, the two operating tabs 2k are simultaneously pushed upwardly by the two end portions Ta and Tb.

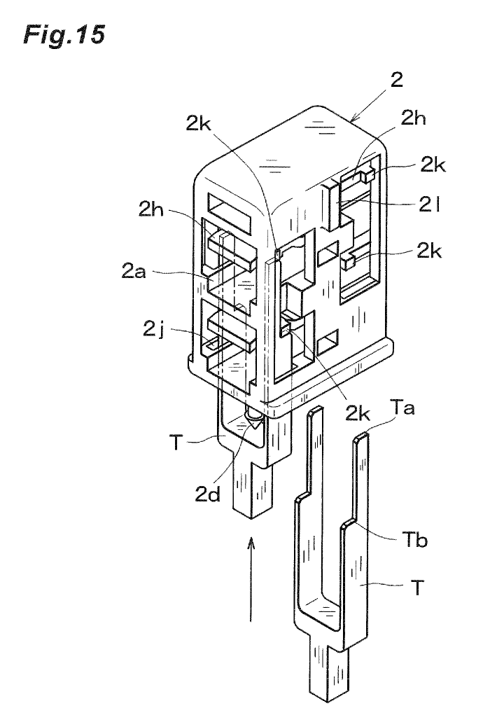

FIG. 15 is an explanatory drawing for explaining the operation of the jig T. In the drawing, the outer holder 1 and wire terminals 3 are not shown. At first, the waterproof member 6 and pin terminal 5 are removed from the outer and inner holders 1 and 2. Then, the jig T is inserted into the inner holder 2 through the slot portions 2j to push the operating tabs 2k of the movable supporting plates 2h upward. That is to say, the end portions Ta and Tb of the jig T are inserted into the slot portions 2j from the bottom through the opening 1c of the outer holder 1, and as shown in a left side of the drawing of FIG. 15, the upper and lower movable supporting plates 2h are simultaneously pushed upward via the operating tabs 2k, and the locking claws 2i are removed from the engaging holes 3c of the wire terminals 3. Then by pulling the electric wires 4, the two wire terminals 3 are simultaneously removed out of the inner holder 2. The remaining two wire terminals 3 may be pulled out of the inner holder 2 by inserting the jig T into the slot portions 2j formed on the other side of the inner holder 2.

In the third embodiment 3, the locking claws 2j are provided on the movable supporting plates 2h and the engaging holes 3c are formed in the wire terminals 3, but according to the invention, depressions may be formed in the movable supporting plates 2h and cooperating projections may be formed on the wire terminals 3.

In the above explained embodiments 1-3, the four wire terminal insertion openings 1a are formed in the outer holder 1 and the four wire terminals 3 are inserted into the outer holder 1, but according to the invention, wire terminal insertion openings more than or less than four may be provided. If one or more wire terminal insertion openings 3a are not closed by electric wires, they may be closed by inserting blind plugs made of a synthetic rubber to prevent undesired water penetration into the outer and inner holders 1 and 2.

Furthermore, in the above embodiments, the four wire terminal insertion openings 1a are formed in the outer holder 1 and the four wire terminals 3 are inserted into the outer holder 1, but according to the invention, wire terminal insertion openings more than or less than four may be formed in the outer holder 1.

The harness connector according to the invention can be advantageously used in harness circuits for automobiles.

1. A connection member comprising an outer holder having a plurality of wire terminal insertion openings and an inner holder insertion opening; an inner holder having wire terminal supporting holes and a pin terminal insertion hole; a pin terminal; and a waterproof member for sealing said inner holder insertion opening of the outer holder; whereby said wire terminal supporting holes are communicated with said wire terminal insertion openings and said pin terminal insertion hole is communicated with said wire terminal supporting holes within the inner holder under a condition that the inner holder is inserted into the outer holder through said inner holder insertion opening; and contacts provided in connecting portions of wire terminals inserted into said inner holder through said wire terminal insertion openings are brought into contact with the pin terminal by inserting the pin terminal into the pin terminal insertion hole and said wire terminals are electrically connected to one another.

2. The connection member according to claim 1, wherein said inner holder includes movable supporting plates for holding the wire terminals in the wire terminal insertion holes of the inner holder, and locking members for fixing the wire terminals in position are provided on said movable supporting plates.

3. The connection member according to claim 1, wherein said waterproof member has formed therein locking holes and said inner holder has formed thereon locking projections which are to be inserted into said locking holes such that said inner holder insertion opening of the outer holder is closed by the waterproof member.

4. The connection member according to claim 1, wherein said waterproof member is secured to a closing member which is integrally formed with the outer holder via hinges, and said inner holder insertion opening is sealed with said waterproof member by closing said inner holder insertion opening by said closing member.

5. The connection member according to claim 1, wherein said pin terminal is inserted into said pin terminal insertion hole through said inner holder insertion opening formed in the outer holder.

6. The connection member according to claim 1, wherein said waterproof member is made of a synthetic rubber.

7. A harness connector comprising an outer holder having a plurality of wire terminal insertion openings and an inner holder insertion opening; an inner holder having wire terminal supporting holes and a pin terminal insertion hole and a pin terminal insertion hole, said wire terminal supporting holes being communicated with said wire terminal insertion openings under a condition that the inner holder is inserted into the outer holder through said inner holder insertion opening and said pin terminal insertion hole being communicated with said wire terminal supporting holes within the inner holder; wire terminals each having a tongue-like connecting portion formed at one end and an electric wire connected to the wire terminal at the other end, said connecting portion being inserted into the wire terminal supporting hole of the inner holder through the wire terminal insertion opening and a waterproof structure being attained between said wire terminal insertion opening and said electric wire by inserting the electric wire through a sealing member; a pin terminal which is brought into contact with contacts provided in the connecting portions of wire terminals inserted into said inner holder by inserting the pin terminal into the pin terminal insertion hole and said wire terminals are electrically connected to one another; and a waterproof member for sealing said inner holder insertion opening of the outer holder.

8. The harness connector according to claim 7, wherein each of said contacts of the wire terminals is formed by a short tubular contact extending in a direction perpendicular to a plane of the connecting portion.

9. The harness connector according to claim 7, wherein said contacts of the wire terminals are inserted into the wire terminal supporting holes of the inner holder through the wire terminal insertion openings of the outer holder and said contacts are fixed in position onto the wire terminal supporting holes by locking the contacts with respect to the inner holder.

10. The harness connector according to claim 9, wherein each of said wire terminal supporting holes of the inner holder has formed therein a movable supporting plate for holding the wire terminal, and a locking portion is provided on said movable supporting plate such that said locking portion is engaged with a locking portion provided in the wire terminal.

11. The harness connector according to claim 10, wherein an operating tab is formed on a side wall of each of said movable supporting plates, and the movable supporting plate is moved by operating the operating tab such that locking portion of the movable supporting plate is disengaged from the locking portion of the wire terminal.

12. A harness circuit for automobiles comprising the harness connector according to claim 7.

13. The connection member according to claim 2, wherein said waterproof member has formed therein locking holes and said inner holder has formed thereon locking projections which are to be inserted into said locking holes such that said inner holder insertion opening of the outer holder is closed by the waterproof member.

14. The connection member according to claim 2, wherein said waterproof member is secured to a closing member which is integrally formed with the outer holder via hinges, and said inner holder insertion opening is sealed with said waterproof member by closing said inner holder insertion opening by said closing member.

15. The connection member according to claim 2, wherein said pin terminal is inserted into said pin terminal insertion hole through said inner holder insertion opening formed in the outer holder.

16. The connection member according to claim 2, wherein said waterproof member is made of a synthetic rubber.

17. The connection member according to claim 3, wherein said waterproof member is made of a synthetic rubber.

18. The connection member according to claim 4, wherein said waterproof member is made of a synthetic rubber.

19. The connection member according to claim 5, wherein said waterproof member is made of a synthetic rubber.
